(19) United States
(12) Patent Application Publication
(10) Pub. No.: US 2025/0203146 A1
(43) Pub. Date: Jun. 19, 2025

(54) HIGH-DEFINITION MULTIMEDIA INTERFACE (HDMI) SIGNAL DETECTION METHOD AND APPARATUS THEREOF

(71) Applicant: MEDIATEK INC., Hsinchu City (TW)

(72) Inventors: Chen-Yi LIU, Hsinchu City (TW); Ko-Yin LAI, Hsinchu City (TW); Chih-Wei CHOU, Hsinchu City (TW); Kuo-Chang CHENG, Hsinchu City (TW); You-Tsai JENG, Hsinchu City (TW); Chin-Lung LIN, Hsinchu City (TW); Hung-Yu SU, Hsinchu City (TW); Chi-Chih CHEN, Hsinchu City (TW); Tai-Lai TUNG, Hsinchu City (TW)

(21) Appl. No.: 18/941,313

(22) Filed: Nov. 8, 2024

Related U.S. Application Data
(60) Provisional application No. 63/610,427, filed on Dec. 15, 2023.

(51) Int. Cl. H04N 21/426; H04N 21/4363

(52) U.S. Cl. CPC H04N 21/42607; H04N 21/43635

(57) ABSTRACT

A High-Definition Multimedia Interface (HDMI) signal detection method is provided. The HDMI signal detection method may be applied to an apparatus (e.g., a sink device). The HDMI signal detection method may include the following steps. The apparatus may receive input data from a source apparatus through an HDMI standard, wherein the input data comprises a plurality of data sets. Then, the apparatus may compare each data set to a predefined reference pattern according to a slide window with the predefined reference pattern to generate a comparison result. Then, the apparatus may determine whether the total match count corresponding to the comparison result is less than a threshold to determine the HDMI standard corresponding to the input data.

### CROSS REFERENCE TO RELATED APPLICATIONS

This application claims the benefits of U.S. Provisional Application No. 63/610,427 filed on Dec. 15, 2023, the entirety of which is incorporated by reference herein.

### BACKGROUND OF THE INVENTION

### Field of the Invention

The invention generally relates to High-Definition Multimedia Interface (HDMI) technology, and more particularly, to an HDMI signal detection.

### Description of the Related Art

A High-Definition Multimedia Interface (HDMI) serves as a conduit for transmitting both video and audio signals. It allows for the transfer of uncompressed video and either compressed or uncompressed audio from a source device, such as a display controller, to a compatible sink device, which could be a computer monitor, video projector, digital television, or digital audio device.

As technology has advanced, the HDMI standard has evolved, resulting in multiple versions with varying capabilities. Among these, HDMI 1.4 and HDMI 2.0 are prevalent in the current market. A key distinction between these versions lies in their clock frequencies. The HDMI 2.0 standard operates at a clock frequency that is quadruple that of HDMI 1.4. This difference in clock speed facilitates the higher bandwidth required by HDMI 2.0 to support features such as increased frame rates, resolutions, and color fidelity. Upon receiving an HDMI signal, the HDMI sink is initially unclear whether the signal conforms to the HDMI 1.4 or HDMI 2.0 standard. To determine the format, the HDMI sink device may initially detect the data using an HDMI 2.0 ratio detect clock rate. Under normal conditions, since the HDMI 2.0 clock frequency is four times that of HDMI 1.4, the pattern of the data can be used to identify the signal type.

FIG. 1 is a timing diagram illustrating the HDMI 1.4 data and the HDMI 2.0 data. As shown in FIG. 1, the processed data pattern to be transmitted via HDMI is a repeating sequence of “0101010 . . . ”. The arrows indicate the HDMI sink device may initially detect the data using at HDMI 2.0 ratio detect clock rate. Since the HDMI 2.0 clock frequency is four times that of HDMI 1.4, when the sink device detects the data pattern is “0101010 . . . ” pattern, the sink device may determine that the data is a HDMI 2.0 data. Conversely, when the sink device detects the data pattern is “00001111100001111 . . . ”, the sink device may determine that the data is an HDMI 1.4 signal.

However, the signal integrity of the input data may be interfered by the noise and crosstalk which may introduce unexpected transitions from ‘0’ to ‘1’ or ‘1’ to ‘0’ in the HDMI 1.4 signal. The interference may potentially lead to a misinterpretation of the sink device. The sink device may incorrectly identify an HDMI 1.4 signal as an HDMI 2.0 signal.

Therefore, how to detect the HDMI 2.0 data and the HDMI 1.4 signal is a topic that is worthy of discussion.

### BRIEF SUMMARY OF THE INVENTION

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods and apparatus pertaining to a High-Definition Multimedia Interface (HDMI) signal detection with respect to a sink device and a source device. It is believed that the above-described issue would be avoided or otherwise alleviated by implementing one or more of the proposed schemes described herein.

An embodiment of the invention provides an HDMI signal detection method. The HDMI signal detection method may be applied to an apparatus (e.g., a sink device). The HDMI signal detection method may comprise the following steps. The apparatus may receive input data from a source apparatus through an HDMI standard, wherein the input data comprises a plurality of data sets. Then, the apparatus may compare each data set to a predefined reference pattern according to a slide window with the predefined reference pattern to generate a comparison result. Then, the apparatus may determine whether the total match count corresponding to the comparison result is less than a threshold to determine the HDMI standard corresponding to the input data.

In some embodiments, the HDMI standard may comprise an HDMI 1.4 standard or an HDMI 2.0 standard.

In some embodiments, the predefined reference pattern may comprise a bit sequence in which 0 and 1 are alternately ordered.

In some embodiments, the length of each data set may be equal to or longer than the predefined reference pattern.

In some embodiments, the apparatus may compare a first subset of the first data set of the plurality of data sets to the predefined reference pattern, wherein the length of the first subset is the same as the predefined reference pattern. Then, the apparatus may increment a match count corresponding to the first data set by 1 in the event that the first subset matches the predefined reference pattern. Then, the apparatus may move the slide window to the next subset of the first data set to compare the next subset to the predefined reference pattern.

In some embodiments, in the event that the first subset does not match the predefined reference pattern, the apparatus may move the slide window to the next subset of the first data set to compare the next subset to the predefined reference pattern.

In some embodiments, the maximum of the match count corresponding to each data set is 1.

In some embodiments, the apparatus may determine that the HDMI standard corresponding to the input data is a first HDMI standard in the event that the total match count corresponding to the comparison result is less than the threshold. In addition, the apparatus may determine that the HDMI standard corresponding to the input data is a second HDMI standard in the event that the total match count corresponding to the comparison result is not less than the threshold.

An embodiment of the invention provides an apparatus. The apparatus may comprise an HDMI interface and a processor. The HDMI interface may receive input data from a source apparatus through an HDMI standard, wherein the input data comprises a plurality of data sets. The processor may be coupled to the HDMI interface. The processor may perform the following operations. The processor may receive, via the HDMI interface, input data from a source apparatus, wherein the input data comprises a plurality of data sets. The processor may compare each data set to a predefined reference pattern according to a slide window with the predefined reference pattern to generate a comparison result. The processor may determine whether the total match count corresponding to the comparison result is less than a threshold to determine the HDMI standard corresponding to the input data.

Other aspects and features of the invention will become apparent to those with ordinary skill in the art upon review of the following descriptions of specific embodiments of the HDMI signal detection method and the apparatus.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a timing diagram illustrating the HDMI 1.4 data and the HDMI 2.0 data.

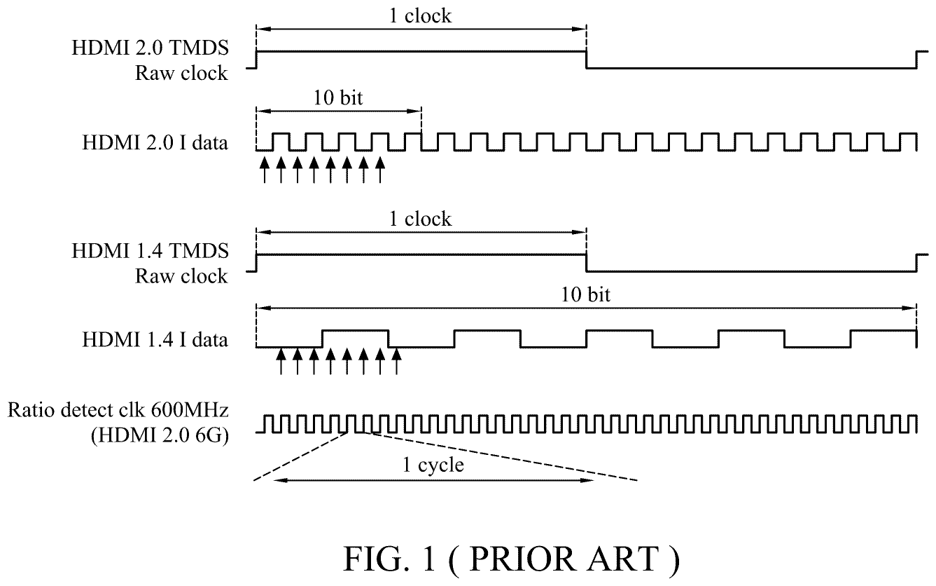

FIG. 2 is a block diagram illustrating an HDMI signal transmission system according to an embodiment of the application.

FIG. 3 is a schematic diagram illustrating a slide window according to an embodiment of the application.

FIG. 4 is a flow chart illustrating an HDMI signal detection method according to an embodiment of the invention.

FIG. 5 is a flow chart illustrating the step S430 according to an embodiment of the invention.

### DETAILED DESCRIPTION OF THE INVENTION

The following description is of the contemplated mode of carrying out the invention. This description is made for the purpose of illustrating the general principles of the invention and should not be taken in a limiting sense. The scope of the invention is best determined by reference to the appended claims.

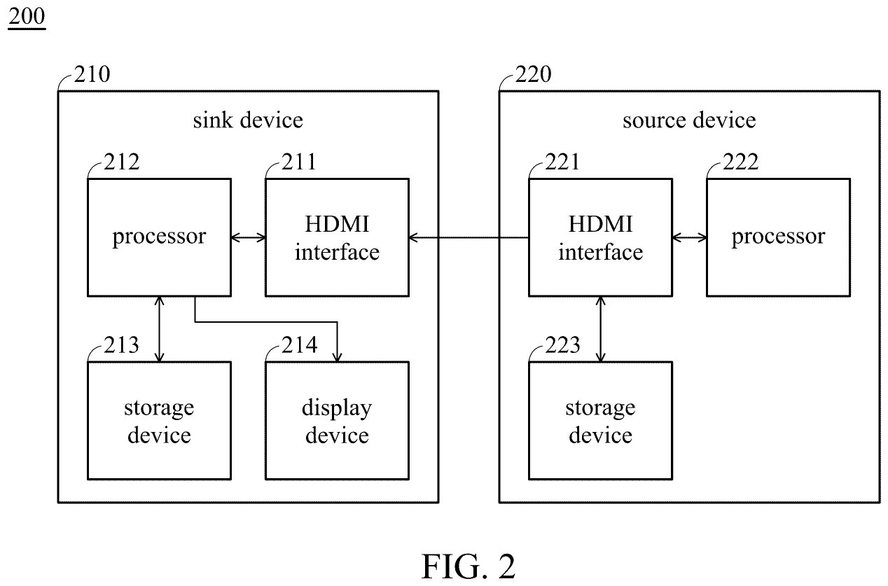

FIG. 2 is a block diagram of a High-Definition Multimedia Interface (HDMI) signal transmission system 200 according to an embodiment of the application. As shown in FIG. 2, the HDMI signal transmission system 200 may include a sink device 210 and a source device 220.

According to an embodiment of the invention, the sink device 210 may be a digital television (DTV), a projector, plasma panel or a liquid crystal display (LCD) display, but the invention should not be limited thereto. The source device 220 may be a set-top box, an HD digital video disc (DVD) Disc player, a computer, a digital-video home system (D-VHS), a Blu-ray Disc player, or a video game console, but the invention should not be limited thereto. The sink device 210 and the source device 220 may support the HDMI signal transmission. That is, the sink device 210 can receive the video data and audio data from the source device 220 through an HDMI interface, and the source device 220 can transmit the video data and audio data to the sink device 210 through an HDMI interface.

As shown in FIG. 2, the sink device 210 may comprise a HDMI interface 211, a processor 212, a storage device 213 and a display device 214. In addition, the source device 220 may comprise a HDMI interface 221, a processor 222, and a storage device 223. It should be noted that, in order to clarify the concept of the invention, FIG. 2 presents a simplified block diagram in which only the elements relevant to the invention are shown. However, the invention should not be limited to what is shown in FIG. 2. The sink device 210 also can comprise other elements.

The sink device 210 may receive the HDMI signals (or data) from the source device 220 through HDMI interface 211.

The processor 212 may be a general-purpose processor, a Central Processing Unit (CPU), a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the HDMI interface 211 for HDMI transmission with the source device 220, storing and retrieving data (e.g., program code) to and from the storage device 213, and sending a series of frame data (e.g. representing text messages, graphics, images, etc.) to the display device 214.

In particular, the processor 212 coordinates the aforementioned operations of the HDMI interface 211, the storage device 213 and the display device 214 for performing the method of the present application.

As will be appreciated by persons skilled in the art, the circuits of the processor 212 may include transistors that are configured in such a way as to control the operation of the circuits in accordance with the functions and operations described herein. As will be further appreciated, the specific structure or interconnections of the transistors may be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 213 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, communication protocols, and/or the method of the present application.

The display device 214 may be a Liquid-Crystal Display (LCD), a Light-Emitting Diode (LED) display, an Organic LED (OLED) display, or an Electronic Paper Display (EPD), etc., for providing a display function. Alternatively, the display device 210 may further include one or more touch sensors for sensing touches, contacts, or approximations of objects, such as fingers or styluses.

In addition, as shown in FIG. 2, the source device 220 may comprise a HDMI interface 221, a processor 222, and a storage device 223. It should be noted that, in order to clarify the concept of the invention, FIG. 2 presents a simplified block diagram in which only the elements relevant to the invention are shown. However, the invention should not be limited to what is shown in FIG. 2. The source device 220 also can comprise other elements.

The source device 220 may transmit the HDMI signals (or data) to the sink device 210 through HDMI interface 221.

The processor 222 may be a general-purpose processor, a CPU, an MCU, an application processor, a DSP, a GPU, an HPU, an NPU, or the like, which includes various circuits for providing the functions of data processing and computing, controlling the HDMI interface 221 for HDMI transmission with the sink device 210, and storing and retrieving data (e.g., program code) to and from the storage device 223.

In particular, the processor 222 coordinates the aforementioned operations of the HDMI interface 221, and the storage device 223 for performing the method of the present application.

As will be appreciated by persons skilled in the art, the circuits of the processor 222 may include transistors that are configured in such a way as to control the operation of the circuits in accordance with the functions and operations described herein. As will be further appreciated, the specific structure or interconnections of the transistors may be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 223 may be a non-transitory machine-readable storage medium, including a memory, such as a FLASH memory or an NVRAM, or a magnetic storage device, such as a hard disk or a magnetic tape, or an optical disc, or any combination thereof for storing data, instructions, and/or program code of applications, communication protocols, and/or the method of the present application.

According to an embodiment of the invention, an apparatus (e.g., sink device 210) may receive input data from a source apparatus (e.g., source device 220) through an HDMI standard. The input data comprises a plurality of data sets. According to an embodiment, the HDMI standard may comprise an HDMI 1.4 standard or an HDMI 2.0 standard, i.e., the input data from the source apparatus may be HDMI 1.4 signal or HDMI 2.0 signal. According to an embodiment, the apparatus may process the input data through the HDMI 2.0 ratio detect clock first before performing the operations about slide window for the input data.

Then, the apparatus may comparing each data set to a predefined reference pattern according to a slide window with the predefined reference pattern to generate a comparison result. According to an embodiment of the invention, the predefined reference pattern may comprise a bit sequence in which 0 and 1 are alternately ordered, e.g., “010”, “0101”, “01010”, “101”, “1010”, “10101”, but the invention should not be limited thereto. The length of each data set may be equal to or longer than the predefined reference pattern.

Specifically, the apparatus may compare first subset of the first data set of the data sets to the predefined reference pattern. The length of the first subset may be the same as the predefined reference pattern.

When the first subset matches the predefined reference pattern (e.g., both the first subset and the predefined reference pattern are “0101”), the apparatus may increment a match count corresponding to the first data set by 1. Then, the apparatus may move the slide window to the next subset of the first data set to compare the next subset to the predefined reference pattern.

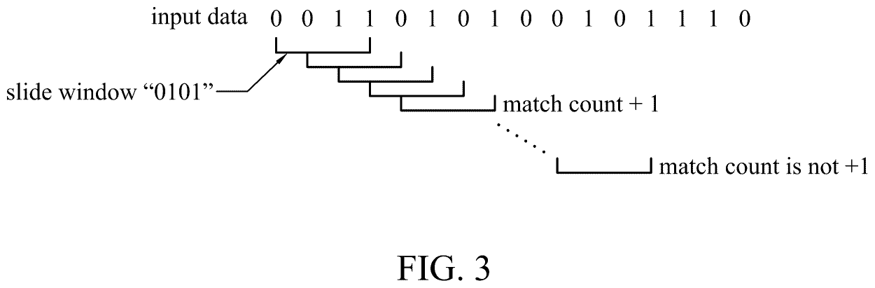

When the first subset does not match the predefined reference pattern (i.e., the first subset is different from the predefined reference pattern), the apparatus may directly move the slide window to the next subset of the first data set to compare the next subset to the predefined reference pattern. It should be noted that, according to an embodiment of the invention, the maximum of the match count corresponding to each data set is 1. That is, when the apparatus detect that another subset of the first data set matches the predefined reference pattern, the apparatus may not increment a match count corresponding to the first data set by 1. Accordingly, the apparatus may perform the same match count calculation for other data sets through the slid window. When the apparatus has compared all data sets (e.g., 60,000 data sets) of the input data to the predefined reference pattern according to the slide window, the apparatus may generate a comparison result according to the match counts corresponding to all data sets (i.e., the total match count). FIG. 3 may be taken as an example for illustrating the embodiments of the invention below, but the invention should not be limited thereto.

FIG. 3 is a schematic diagram illustrating a slide window according to an embodiment of the application. The slide window may be applied to the HDMI signal transmission system 200. As shown in FIG. 3, it may be assumed that the predefined reference pattern is a 4-bit pattern “0101”, and a data set of input data (or data signal) comprises 16-bit “0011010100101110”. The apparatus may uses the predefined reference pattern format as a slide window to examine or detect the data set after the input data has been processed by an HDMI 2.0 ratio detect clock. Firstly, the apparatus may compare the first subset (i.e., “0011”) of the data set to the predefined reference pattern (i.e., “0101”). The first subset of the does not match the predefined reference pattern. Therefore, the apparatus may move the slide window (e.g., move 1 bit) to the next subset (i.e., “0110”) of the data set, and compare the next subset (i.e., “0110”) of the data set to the predefined reference pattern (i.e., “0101”). Accordingly, the apparatus may detect that the fifth subset (i.e., “0101”) of the data set matches the predefined reference pattern (i.e., “0101”), the apparatus may increment a match count corresponding to the data set by 1. Because the maximum of the match count corresponding to each data set is 1. Therefore when the apparatus detect that another subset of the data set matches the predefined reference pattern, the apparatus may not increment the match count corresponding to the data set by 1. When the match count calculation for the data set has been completed, the apparatus may perform the same operations for the next data set of the input data.

After the apparatus has obtained the comparison result, the apparatus may determine whether the total match count corresponding to the comparison result is less than a threshold (e.g., 64, but the invention should not be limited thereto) to determine the HDMI standard corresponding to the input data. Specifically, when the total match count corresponding to the comparison result is less than the threshold, the apparatus may determine that the HDMI standard corresponding to the input data is a first HDMI standard. When the total match count corresponding to the comparison result is not less than the threshold, the apparatus may determine that the HDMI standard corresponding to the input data is a second HDMI standard. For example, when the total match count (e.g., 49) corresponding to the comparison result is less than the threshold (e.g., 64), the apparatus may determine that the HDMI standard corresponding to the input data from the source apparatus is the HDMI 1.4 standard (i.e., the input data is HDMI 1.4 signal). When the total match count corresponding to the comparison result is not less than the threshold, the apparatus may determine that the HDMI standard corresponding to the input data from the source apparatus is the HDMI 2.0 standard (i.e., the input data is HDMI 2.0 signal).

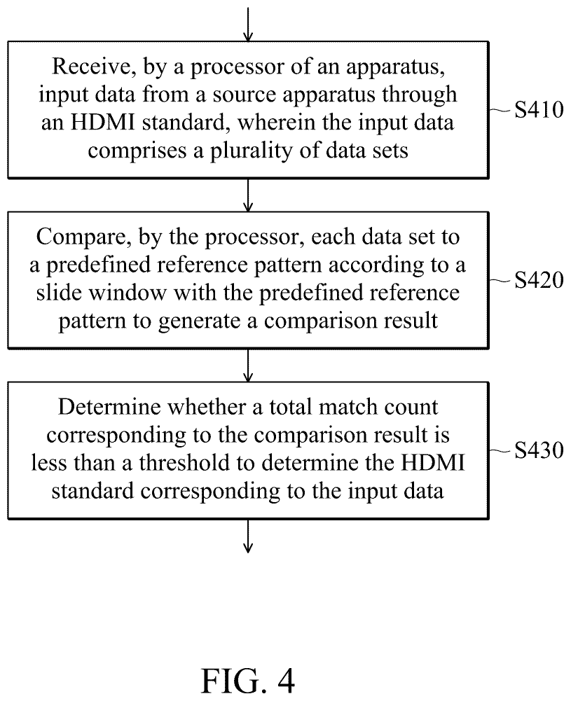

FIG. 4 is a flow chart illustrating an HDMI signal detection method according to an embodiment of the invention. The HDMI signal detection method can be applied to the HDMI signal transmission system 200. As shown in FIG. 4, in step S410, an apparatus (e.g., the sink device 210 of the HDMI signal transmission system 200) may receive input data from a source apparatus (e.g., the source device 220 of the HDMI signal transmission system 200) through an HDMI standard, wherein the input data comprises a plurality of data sets.

In step S420, the apparatus may compare each data set to a predefined reference pattern according to a slide window with the predefined reference pattern to generate a comparison result.

In step S430, the apparatus may determine whether the total match count corresponding to the comparison result is less than a threshold to determine the HDMI standard corresponding to the input data.

According to an embodiment of the invention, in the HDMI signal detection method, the HDMI standard may comprise an HDMI 1.4 standard or an HDMI 2.0 standard.

According to an embodiment of the invention, in the HDMI signal detection method, the predefined reference pattern may comprise a bit sequence in which 0 and 1 are alternately ordered.

According to an embodiment of the invention, in the HDMI signal detection method, the length of each data set may be equal to or longer than the predefined reference pattern.

According to an embodiment of the invention, in the HDMI signal detection method, the apparatus may also compare a first subset of the first data set of the plurality of data sets to the predefined reference pattern, wherein the length of the first subset is the same as the predefined reference pattern. The apparatus may also increment a match count corresponding to the first data set by 1 in the event that the first subset matches the predefined reference pattern. The apparatus may further move the slide window to the next subset of the first data set to compare the next subset to the predefined reference pattern.

According to an embodiment of the invention, in the HDMI signal detection method, in the event that the first subset does not match the predefined reference pattern, the apparatus may also move the slide window to the next subset of the first data set to compare the next subset to the predefined reference pattern.

According to an embodiment of the invention, in the HDMI signal detection method, the maximum of the match count corresponding to each data set may be 1.

According to an embodiment of the invention, in the HDMI signal detection method, the apparatus may also determine that the HDMI standard corresponding to the input data is a first HDMI standard in the event that the total match count corresponding to the comparison result is less than the threshold. In addition, the apparatus may also determine that the HDMI standard corresponding to the input data is a second HDMI standard in the event that the total match count corresponding to the comparison result is not less than the threshold.

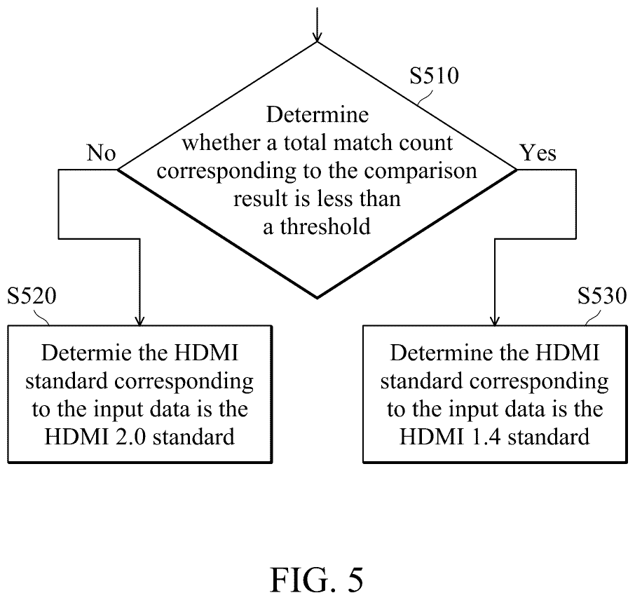

FIG. 5 is a flow chart illustrating step S430 according to an embodiment of the invention. As shown in FIG. 5, in step S510, the apparatus may determine whether the total match count corresponding to the comparison result is less than a threshold.

When the total match count corresponding to the comparison result is not less than the threshold, step S520 is performed. In step S520, the apparatus may determine that the HDMI standard corresponding to the input data is the HDMI 2.0 standard (i.e., the input data is HDMI 2.0 signal).

When the total match count corresponding to the comparison result is less than the threshold, step S530 is performed. In step S530, the apparatus may determine that the HDMI standard corresponding to the input data is the HDMI 1.4 standard (i.e., the input data is HDMI 1.4 signal).

According to the HDMI signal detection method provided in the invention, the sink device can more accurately determine the input data from the source device is HDMI 2.0 signal or the HDMI 1.4 signal. Therefore, the misjudgment for detecting the HDMI 2.0signal and the HDMI 1.4 signal will be reduced when the input signal received by the sink device is interfered by the noise or the crosstalk.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A High-Definition Multimedia Interface (HDMI) signal detection method, comprising:
receiving, by a processor of an apparatus, input data from a source apparatus through an HDMI standard, wherein the input data comprises a plurality of data sets;
comparing, by the processor, each data set to a predefined reference pattern according to a slide window with the predefined reference pattern to generate a comparison result; and
determining, by the processor, whether a total match count corresponding to the comparison result is less than a threshold to determine the HDMI standard corresponding to the input data.

2. The HDMI signal detection method of claim 1, wherein the HDMI standard comprises an HDMI 1.4 standard or an HDMI 2.0 standard.

3. The HDMI signal detection method of claim 1, wherein the predefined reference pattern comprises a bit sequence in which 0 and 1 are alternately ordered.

4. The HDMI signal detection method of claim 1, wherein a length of each data set is equal to or longer than the predefined reference pattern.

5. The HDMI signal detection method of claim 1, further comprising:
comparing, by the processor, a first subset of a first data set of the plurality of data sets to the predefined reference pattern, wherein a length of the first subset is the same as the predefined reference pattern;
incrementing, by the processor, a match count corresponding to the first data set by 1 in an event that the first subset matches the predefined reference pattern; and
moving, by the processor, the slide window to a next subset of the first data set to compare the next subset to the predefined reference pattern.

6. The HDMI signal detection method of claim 5, further comprising:
in an event that the first subset does not match the predefined reference pattern, moving, by the processor, the slide window to the next subset of the first data set to compare the next subset to the predefined reference pattern.

7. The HDMI signal detection method of claim 1, wherein a maximum of a match count corresponding to each data set is 1.

8. The HDMI signal detection method of claim 1, further comprising:
determining, by the processor, the HDMI standard corresponding to the input data is a first HDMI standard in an event that the total match count corresponding to the comparison result is less than the threshold; and
determining, by the processor, the HDMI standard corresponding to the input data is a second HDMI standard in an event that the total match count corresponding to the comparison result is not less than the threshold.

9. An apparatus, comprising:
a High-Definition Multimedia Interface (HDMI) interface, receiving input data from a source apparatus through an HDMI standard, wherein the input data comprises a plurality of data sets; and
a processor, coupled to the HDMI interface, and performing operations comprising:
receiving, via the HDMI interface, input data from a source apparatus, wherein the input data comprises a plurality of data sets; and
comparing each data set to a predefined reference pattern according to a slide window with the predefined reference pattern to generate a comparison result; and
determining whether a total match count corresponding to the comparison result is less than a threshold to determine the HDMI standard corresponding to the input data.

10. The apparatus of claim 9, wherein the HDMI standard comprises an HDMI 1.4 standard or an HDMI 2.0 standard.

11. The apparatus of claim 9, wherein the predefined reference pattern comprises a bit sequence in which 0 and 1 are alternately ordered.

12. The apparatus of claim 9, wherein a length of each data set is equal to or longer than the predefined reference pattern.

13. The apparatus of claim 9, wherein the processor further performs operations comprising:
comparing a first subset of a first data set of the plurality of data sets to the predefined reference pattern, wherein a length of the first subset is the same as the predefined reference pattern;
incrementing a match count corresponding to the first data set by 1 in an event that the first subset matches the predefined reference pattern; and
moving the slide window to a next subset of the first data set to compare the next subset to the predefined reference pattern.

14. The apparatus of claim 13, wherein the processor further performs operations comprising:
in an event that the first subset does not match the predefined reference pattern, moving, by the processor, the slide window to the next subset of first data set to compare the next subset to the predefined reference pattern.

15. The apparatus of claim 9, wherein a maximum of a match count corresponding to each data set is 1.

16. The apparatus of claim 9, wherein the processor further performs operations comprising:
determining that the HDMI standard corresponding to the input data is a first HDMI standard in an event that the total match count corresponding to the comparison result is less than the threshold; and
determining that the HDMI standard corresponding to the input data is a second HDMI standard in an event that the total match count corresponding to the comparison result is not less than the threshold.
